(19) United States
(12) Patent Application Publication
(10) Pub. No.: US 2016/0075602 A1
(43) Pub. Date: Mar. 17, 2016

(54) Polymeric Concrete Admixture Containing a New Class of Superplasticizer Polymers

(71) Applicant: POLYMERIUM, LLC, Cheyenne, WY (US)

(72) Inventors: Paul W. SCHMALZL, Greenville, SC (US); Robert L. WARREN, San Diego, CA (US)

(73) Assignee: Polymerium, L.L.C., Cheyenne, WY (US)

(21) Appl. No.: 14/784,315

(22) PCT Filed: Apr. 18, 2014
(86) PCT No.: PCT/US14/34592

§ 371 Date: Oct. 14, 2015

Related U.S. Application Data
(60) Provisional application No. 61/813,732, filed on Apr. 19, 2013.

(51) Int. Cl. C04B 26/06

(52) U.S. Cl. CPC C04B 26/06

(57) ABSTRACT

A novel admixture approach to be used in various concrete formulations as a means of modifying and enhancing performance of the concrete. This invention will provide benefits in a variety of ways, including enhanced control over concrete curing times, increased strength and beneficial changes in concrete formulations, particularly useful for specific applications.

This application claims the benefit of U.S. Provisional Application No. 61/813,732, entitled “Polymeric Concrete Admixture Containing a New Class of Superplasticizer Polymers,” filed Apr. 19, 2013, the contents of which are hereby incorporated by reference.

### BACKGROUND OF INVENTION

Concrete, in various forms, has been used for millennia. Throughout the history of its use, formulations have varied, largely due to the available resources. These formulations were enhanced by the inclusion of various additives, commonly called admixtures.

With a better understanding of concrete chemistry, specific admixtures were developed to enhance certain characteristics of the concrete. From the earliest days, these admixtures were commonly available materials. For example, using sugars were known to alter the cure time of concrete, which usually increased its strength.

Many of the admixture efforts have come from experimentation and build on existing solutions. More recently, new chemical compounds have been considered to enhance some aspect of the concrete. Many of these are accelerants, aimed to provide faster cure times without sacrificing quality. Others are retarders, aimed at slowing the cure time to ensure longer times for working/finishing the concrete and better overall curing and concomitant performances. Still others are specifically introduced to help the dispersion of admixtures throughout a concrete mix.

The history of concrete admixtures is documented in U.S. Pat. No. 6,858,074 (Anderson, et al) and is incorporated here in as reference. The term polycarboxylate high range water reducing dispersant throughout this specification refers to polymers with a carbon backbone with pendant side chains, wherein at least a portion of the side chains are attached to the backbone through a carboxyl group.

The term dispersant is also meant to include those chemicals which also function as a plasticizer, water reducer, fluidizer, antiflocculating agent, or superplasticizer for cementitious compositions. Examples of polycarboxylate high range water reducing dispersants can be found in U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, and U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference.

Further, U.S. Pat. No. 5,494,516 discloses a process for modifying the slump of a concrete or mortar by the addition at different times of a water-soluble poly(alkylene oxide) and a β-naphthalene sulphonate-formaldehyde condensate, a plasticizer or superplasticizer.

U.S. Pat. No. 5,792,252 discloses a process producing a cementitious composition that has a set time which is initially retarded for extended workability, followed by accelerated hardening comprising adding to a cementitious composition an admixture of a) an alkali metal carbonate and b) a mono- or di-carboxylic acid which is used as an accelerator.

The invention disclosed herein is a novel admixture solution that can address each enhancements as well as provide a new means to enhance overall concrete performance.

### SUMMARY OF THE INVENTION

The invention described in this disclosure provides a novel admixture approach to be used in various concrete formulations. This invention will provide benefits in a variety of ways, including enhanced control over concrete curing times, increased strength and beneficial changes in concrete formulations, particularly useful for specific applications.

In the preferred embodiment, a high-water content polymer is used to retard the curing process and incorporating specific elements that enhance the overall performance of the concrete. This performance enhancement may be as a result of the curing process, the strength or other characteristics of the concrete or the ability of the concrete to adhere to incorporated reinforcement materials.

Several alternative implementations are described herein. These alternative implementations include various means of incorporating elements in sufficient amounts to beneficially modify the characteristics of the concrete and adding the polymer to the concrete mixture. An implementation to provide for surface wetting during the curing period is also described.

### DETAILED DESCRIPTION OF THE INVENTION

Admixtures for concrete come in very different forms. From common sugar to extravagant, high-cost solutions properly selected and implemented admixtures can be quite effective. However, there are few admixtures that offer the flexibility found in this invention. As will be shown, this invention provides not only specific admixtures but a new means for consistent admixture creation yielding predictable and reliable results.

Like some of the more common admixtures, the baseline used for this invention is a polymer. More specifically, this invention relies on high water content polymers like those disclosed in U.S. Pat. No. 6,201,089 which by design contain high percentages of hydroxyl groups. Polymers that contain high numbers of hydroxyl groups are commonly referred to as polyols. The reader will understand that these polymers are simply exemplars and any number of others may be considered.

Polymers have been used in concretes before, but most are very specific versions aimed to replicate simple polyols or to help dispersion of admixtures. Examples of these are disclosed in U.S. Pat. No. 6,858,074 and are incorporated here is as references. These proposals provide limited benefit when compared to this invention.

Using a polymer like those identified above bring some specific advantages. In the basic form, these polymers have significant quantities of hydroxyl groups. These hydroxyl groups not only bond to elements within the concrete composition, but alter the curing characteristic and also retain water within the concrete. This can also be adjusted or tailored quite specifically by the selection of the monomers and cross-linkers used in the polymer creation process.

Additionally, the nature of the example polymer herein allows for specific elements to be introduced during the polymerization process. Such introduction may take the form of a metal-bearing monomer being used to form the basic polymer.

An example of this is ferro-methacrylate, which can be used instead of or in a mix with methyl-methacrylate to introduce an iron element into the polymer molecule. Moreover, the ability to polymerize with such additives in relatively small batches economically and in a variety of methods (e.g., solution polymerization, bulk polymerization or UV polymerization) provides the utmost flexibility for this application. This polymer may be introduced into the concrete mixture in sufficient quantities to enhance the performance but without proving detrimental to the overall mixture.

Another approach to allowing the introduction of desired elements is the introduction of the desired element during the polymer hydration process. The unique bonding characteristics of the polymer molecule make it a suitable carrier for elements. In the case of the previously identified polymer compositions, hydration takes place with a normal saline solution. During hydration, a sodium atom bonds to the polymer molecule. This bonded sodium atom helps the hydrophilic characteristics of the polymer. In effect, the polymer becomes a carrier for the sodium atom that can be provided to other, more desirable bonding sites.

Hydrated with an alkali or alkaline earth bicarbonate or carbonate solution can enable the same carrier quality for other elements. For example, the use of a hydration solution containing a bondable barium atom may allow for the delivery of the barium atom into the concrete curing process.

In an alternative application, additional steps may be beneficial. For example, some polymers that may be used as admixtures can be used to chelate specific elements. This chelation ability may be usable in order to ensure uptake and distribution of a desired element throughout the concrete mixture. Other elements that can be chelated are: alkali, alkaline earth, transition elements, Lanthanide elements as examples.

The novel integration of the chelation ability of a polymer into the admixing process may greatly reduce cost of elements and processing. For example, lower quality source material for a desired element may be available at a lower cost. With the polymer's metal chelation ability, it can incorporate the desired element quickly and cost effectively without the need for additional processing of the element source material prior to admixing.

Extending this chelation capability to various heavy metals, including poisonous, heavy metals or radioactive elements, the polymer can be used to bond these elements into a concrete matrix effectively entombing said elements in a long-lasting, stable and non-leachable form for long term storage and disposal.

The incorporation of well-known insulators can be a very interesting enhancement to this invention. The introduction of boron, even in small quantities, may provide some level of radiation shielding without the high cost of currently available options.

The ability to use simultaneously multiple variations of the subject polymer admixture composition is a further enhancement. Such may be necessary for specific applications of concrete.

A variation on this enhancement is the ability to layer concrete mixtures with different characteristics that are modulated by the polymer and/or an element introduced as part of the polymer admixture. This may be considered along the lines of a concrete version of multi-layer laminates like plywood, using the unique characteristics of each later to provide particular strength with boding between the layers.

An alternative to using the same polymer admixture while wetting the surface during curing is to use a different polymer admixture. Such a difference may provide for unique surface characteristics while not affecting the overall characteristics of the concrete. This may be further enhanced by incorporating a tint or color into the polymer for application to the surface.

The inherent hydroxyl groups found in polymers like those cited as examples will help the polymer act as a retarder; that is, a means to slow down—retard—the concrete curing process. Such is beneficial in many cases, particularly where additional hardness characteristics are desired. The addition of metal ions, whether by incorporation during polymerization, during hydration or at some other stage in the process, may further enhance the retarder characteristics of the admixture.

It is important, however, to understand that strategic selection of the element to be introduced with the polymer may also provide characteristics of an accelerator. Accelerators are incorporated to speed-up the curing period and are particularly useful for many concrete needs that require fast green strength development when required to support loads after a short time period. For the purposes of this description, “green strength” is defined as the point at which the concrete has cured to be usable but not yet fully cured.

An additional enhancement of this invention is the incorporation into the admixture that provides for better performance in very specific climate conditions. For example, the incorporation of a significant amount of polymer admixture that has included a compound like polyethylene glycol may provide better cold weather performance by help reduce cracking.

Still another enhancement to this invention is to incorporate elements that enable the concrete to bond more completely with any reinforcement materials used. For example concrete bonds to reinforcing steel (e.g., re-bar) via a combination of oxidation and physical containment. The addition of specific elements may allow the concrete to bond more completely at a molecular level.

An example of this is incorporation of siloxy-acrylic monomers in the polymer which upon hydration and mixing with the cement at the high pH of cement mixtures will react with the iron oxide surface of the rebar and the silicone-aluminate of the Portland concrete to create a covalent bond between the concrete and the structural iron rebar of the pour.

An expansion of this approach is to utilize monomers that can be considered “spacer monomers” into the polymer that will chelate iron atoms after the concrete is poured. Effectively enabling the polymer to act as an oxime, which have well-known metal chelation capability, iron atoms from re-bar and other encapsulated metal components are chelated in order to stop auto-corrosive behavior of the iron. This anti-corrosive function can be useful for long-term structures and reduce the potential for failure or other degradation.

An advantage of using many polymers is that they can be added during the dry mixing process. This can present several advantages, particularly to enable a general-purpose source wants to provide custom mixes. In such a case, as the dry ingredients are deposited into a mixing vessel like a cement mixing truck, specific admixtures can be introduced. Water is then added to the mixing vehicle without any specific differentiation. Thus, either a specific dried polymer, which may have been previously hydrated, containing a desired element can be added to the dry concrete mix to be later rehydrated by the water addition; or a hydrated gel is added to the wet concrete during mixing to add the desired element and polymer to the concrete.

Particularly beneficial to high-water polymers is the ability to introduce the admixture to the water itself. This has the advantage of ensuring distribution by the physical mixing process along with any other liquid additives. The use of a hydrated polymer will also allow for application of the polymer to the concrete surface during curing. This technique is used in many locations, particularly warms sites, to keep the top layers of the concrete from drying out before curing occurs.

In the preferred embodiment, the polymer is created as specified in the example polymer cited above using a solution polymerization technique. After polymerization, the polymer is dried and powdered. This allows for easier storage of the polymer and less costly shipment due to its lightweight. Additionally the hydrated gel can be used as the admixture directly thus avoiding the costs of drying and powdering the polymer.

At the location where concrete is to be mixed, the use of the polymer as a retarder only (i.e., no additional elements will be introduced) allows it to be added either with the dry ingredients like Portland cement, sand, aggregate and any desired coloring compound, or with the water at the final stage.

In the preferred embodiment, the polymer is added at the water stage by adding polymer powder into the water stream. This can alternatively be done by pre-mixing the polymer with water to provide a low-viscosity slurry.

In an alternative embodiment, a set of hydration solutions are provided in order to not only hydrate the polymer but also to introduce selected metal ions. The appropriate one is added after determining the optimal characteristics of the concrete. While the polymer can then be dried again for introduction as a dry ingredient, in this case it is preferentially added as a wet mixture.

After pouring the concrete, in the preferred embodiment water that contains the hydrated polymer will be sprayed on during the curing period to ensure additional water retention and reduce the likelihood of early drying out of the outer surfaces of the concrete.

An alternative to using a small amount of the polymer as an admixture to concrete, creating a more viscous water and polymer solution to be incorporated into the concrete mix may allow for better implementation of the concrete in locations that would otherwise be difficult to fill (e.g., a slope). The polymer and water could be thought of as a gel that is mixed with the other cement element and thereby provide a readily spreadable mixture without relying on a too-dry mixture as is typically done in such cases. With sufficient amounts of the gel, the polymer provides some of the structural support required during pouring and curing.

An alternate enhancement is to employ the gelatinous nature of the polymer in a mortar or stucco mix to provide a “wet-structural strength” to assist in holding the mix in place before and during the curing process.

While the description above has used traditional, large-scale concrete mixing operations, the process can be just as easily provided to small applications as well. For example a home user who mixes concrete in a wheelbarrow or bucket in small batches—to install a mailbox stand, for example—can add the dry or hydrated polymer in small quantities and gain requisite benefits.

Further extensions of the preferred embodiment may allow for solution polymerization in a manner that does not require the solution used to be removed from the polymer. For example, one can envision a polymerization process that relies on a polyethylene glycol as the polymerization solution. This entire solution, including the polymer may be added in whole to a concrete mix in order to affect certain characteristics in the concrete.

The invention disclosed herein is novel in several respects. The examples that follow provide embodiments incorporating novel features of the invention.

For the purpose of these examples, a polymer like that described in U.S. Pat. No. 6,201,089 ('089) will be used. That polymer is a polyHEMA-based polymer derived from the contact lens industry but with applicability to a wide range of applications. Most attractive to this category of polymers is the high content of hydroxyl groups.

### EXAMPLE ONE

In this example, the polymer is to be used solely for its retarder capabilities. That is, the dry powder form of the polymer will be added along with the dry materials of Portland cement, sand and stone. As the mixer rotates it will mix these ingredients and water will be added. The cement mix will then be poured into the pre-built forms and allowed to cure in place. During this cure period, which will be significantly longer due to the addition of the polymer admixture that is inherently hydrophilic and less quick to release water in the concrete.

### EXAMPLE TWO

To prevent excessive water loss during the cure time, the surface will be sprayed with a water solution that includes an added amount of the polymer. Using a dry polymer with the water spray will use techniques similar to those using a vessel inline with the water source will meter out the polymer as it is mixed with the source water prior to application. This surface coating of the water retention polymer is meant to replace the various coverings used to prevent water evaporation from the curing concrete.

### EXAMPLE THREE

To the concrete mix after the addition of the water is added a hydrated 95% water-containing superplasticizer polymer gel. This gel is used in place of the dry powdered polymer shown in Example One. The concrete or mortar is mixed sufficiently to incorporate the gel into the mix and also to form micro-air bubbles in the mix. This air entrainment is formed to lighten the concrete weight without detrimental effects on the strength of the cured concrete.

### EXAMPLE FOUR

As in Example Three, a prehydrated superplasticizer polymer gel that has had other alkali or alkaline earth metals incorporated in the gel can be used to introduce these metals into the concrete or mortar mix for the purpose of enhancing the properties of the cured mix by those metals.

Another enhanced feature of the polymeric concrete admixture is the ability to uniquely identify the concrete. Such may be a unique molecule or other chemical marker not typically found in concrete but available with sufficient diversity to uniquely identify a mix, its source or its intended customer. The use of very specific variants of the polymer and/or the incorporation of a marker in specific batches may be helpful in forensic investigations.

Still another enhancement is the incorporation into the admixture specific elements that can be monitored for curing and integration. For example, one may incorporate elements during hydration of the polymer that will either bond with the concrete during curing or due to the heat of curing will outgas from the concrete. Being able to monitor for such outgassing may provide an alert to adequate or inadequate curing.

While specific polymer types and embodiments are cited in this description, it will be well understood by those schooled in the art that variations are possible. Nothing in this description is to be read as limiting with respect to such potential variations. Moreover, while synthetic polymers are used for example purposes, the invention disclosed herein may be applicable to the use of naturally derived or hybrid natural/synthetic formulations.

What is claimed is:

1. A polymeric concrete admixture in which the polymer is a high-water content polymer.

2. The polymer of claim 1 in which the polymer is of a polyHEMA class

3. The polymer of claim 1 in which a monomer of the polymer contains at least one specific metal.

4. The polymer in claim 2 in which the monomer mixture contains ferro-methacrylate.

5. The polymer of claim 1 in which the polymer acts as a carrier for a metal element to be introduced into the concrete.

6. The polymer of claim 5 in which the metal element carried by the polymer is barium.

7. The polymer of claim 5 in the metal element carried by the polymer is boron.

8. The polymer of claim 1 that can chelate specific elements in order to incorporate those elements into the concrete mixture.

9. The polymer of claim 8 in which the element to be chelated comes is from an alkali, alkaline earth, transition element, Lanthanide or Actinide class.

10. The polymer of claim 1 in which the polymer may be applied to the surface of the concrete mixture.

11. The polymer of claim 10 in which the polymer applied to the surface of the concrete mixture interacts with one or more polymers incorporated into the concrete mixture.

12. A polymeric concrete admixture that provides for multiple polymers to be added to a concrete mixture

13. A polymeric concrete admixture in which different polymers or mixes of polymers may be added to concrete mixtures to enable layered concrete mixtures providing unique characteristics to the concrete composite.

14. The polymeric concrete admixture of claim 13 in which at least one of the concrete layers includes no polymer.

15. A polymeric concrete admixture in which the polymer includes a means of bonding concrete to a reinforcement structure.

16. The polymer of claim 15 in which the means for bonding is provided as a monomer of the polymer.

17. The polymer of claim 16 in which the monomer is of a siloxy-acrylic class.

18. The polymer of claim 15 in which the means for bonding is provided by another element incorporated into the polymer.

19. A polymeric concrete admixture in which multiple polymers are introduced into the concrete mixture.

20. The polymers of claim 19 in which each polymer is of a different composition.

21. The polymers of claim 19 in which each polymer incorporates different elements.

22. The polymers of claim 21 in which the different elements are incorporated as monomers in the respective polymers.

23. The polymers of claim 21 in which the different elements are incorporated in the respective polymers via a means other than as monomers of the respective polymers.

24. The polymers of claim 21 in which the different elements are incorporated by a mix of monomers and other than monomers.

25. A polymeric concrete admixture in which the polymer polymerization occurs during the concrete mixing process.

26. A polymeric concrete admixture in which the polymer is designed to enhance performance during extreme environmental conditions.

27. The conditions of claim 26 that include extreme cold or hot temperatures.

28. The conditions of claim 26 that include very high or very low humidity.

29. The polymer of claim 26 in which the polymer incorporates one of polyethylene or polypropylene glycol.

30. Addition of polymer on the surface to improve curing

31. Polymeric concrete admixture in which the polymer is polymerized, neutralized, dried and powdered prior to introduction into the concrete mixture.

32. Polymer of claim 31 in which the powdered polymer is added with the water to the concrete mixture.

33. Polymeric concrete admixture in which the polymer is polymerized, neutralized and hydrated into a gel form prior to introduction to the concrete mixture

34. Polymer additive to increase viscosity of the concrete in order to enable better stability during curing in non-level surfaces

35. Polymer incorporates a means to provide indication of curing status

36. Claim 35 in which outgassing resulting from curing provides the means of indication.

37. Polymer that incorporate unique molecules in order to identify specific mixtures of concrete
